(19) United States
(12) Patent Application Publication
(10) Pub. No.: US 2015/0330645 A1
(43) Pub. Date: Nov. 19, 2015

(54) COMFORT ESTIMATION AND INCENTIVE DESIGN FOR ENERGY EFFICIENCY

(71) Applicant: UNITED TECHNOLOGIES CORPORATION, Hartford, CT (US)

(72) Inventors: Alberto Speranzon, South Glastonbury, CT (US); Tuhin Sahai, Cambridge, MA (US); Andrzej Banaszuk, Simsbury, CT (US)

(21) Appl. No.: 14/648,056

(22) PCT Filed: Nov. 29, 2012
(86) PCT No.: PCT/US2012/067029

§ 371 Date: May 28, 2015

(51) Int. Cl. F24F 11/00; G05B 15/02; G06N 5/04

(52) U.S. Cl. CPC F24F 11/006; G06N 5/04; G05B 15/02

(57) ABSTRACT

A method for providing comfort estimation for a space includes receiving sensor data identifying an environmental condition for the space; receiving comfort data from occupants of the space combining the sensor data and comfort data to provide combined data; generating a comfort relation network in response to the combined data; and performing network analysis on the comfort relation network to identify communities within the comfort relation network.

### FIELD OF THE INVENTION

Embodiments relate generally to energy efficiency, and more particularly, to using comfort estimation and incentive design to improve energy efficiency.

### BACKGROUND

The comfort of occupants in a building depends on many factors including metabolic rates, clothing, air temperature, mean radiant temperature, air velocity, humidity, lighting, noise, etc. Although, in most buildings, only temperature, humidity, lighting and air ventilation (e.g., CO2) can be controlled, it is usually very difficult to control these quantities specifically for comfort. Typically, the building manager decides setpoints based on general comfort metrics determined by prescribed standards, which provides environmental conditions that are acceptable to approximately 80% of the occupants in a building. However, in many instances the comfort level provided by the HVAC, lighting, and other systems does not meet the expectation of the occupants. Additionally, in shared spaces, it is difficult if not impossible to provide a comfort level that is acceptable to all occupants. This creates situations where people are uncomfortable and a large amount of energy is used (wasted) to maintain aero-thermal, lighting, and other conditions that are not optimal for occupants. A building manager does not have information about comfort level of the occupants, except in situations where the comfort level is unbearable and occupants complain. The lack of this information prevents a building manager from optimizing setpoints both for comfort as well as for energy purposes.

Recently, some studies have been conducted in student dorms in various colleges and universities where dashboards showing room/floor/building energy consumption were used in a competitive setting. More precisely, energy consumption was monitored at various levels in a few buildings and ranking provided in real-time for the most efficient building/floor/room. Prizes were given to people that scored highest at the end of the study. Studies have shown that peer-pressure through a competition provides a way to save up to 8.7%, in average, of electrical energy usage.

### BRIEF SUMMARY

An embodiment includes a method for providing comfort estimation for a space by receiving sensor data identifying an environmental condition for the space; receiving comfort data from occupants of the space combining the sensor data and comfort data to provide combined data; generating a comfort relation network in response to the combined data; and performing network analysis on the comfort relation network to identify communities within the comfort relation network.

Another embodiment includes a system for providing comfort estimation for a space, the system including a data fusion module receiving sensor data identifying an environmental condition for the space, receiving comfort data from occupants of the space and combining the sensor data and comfort data to provide combined data; a comfort relation network estimation module generating a comfort relation network in response to the combined data; and a network analysis module performing network analysis on the comfort relation network to identify communities within the comfort relation network.

Another embodiment includes a computer program embodied on a non-transitory computer-readable storage medium, the computer program including instructions for causing a processor to implement a process for providing comfort estimation for a space, the process including receiving sensor data identifying an environmental condition for the space; receiving comfort data from occupants of the space; combining the sensor data and comfort data to provide combined data; generating a comfort relation network in response to the combined data; and performing network analysis on the comfort relation network to identify communities within the comfort relation network.

Other aspects, features, and techniques of the invention will become more apparent from the following description taken in conjunction with the drawings.

### BRIEF DESCRIPTION OF THE SEVERAL VIEWS OF THE DRAWINGS

Referring now to the drawings wherein like elements are numbered alike in the Figures:

FIG. 1 illustrates a comfort estimation and incentive system in an exemplary embodiment;

FIG. 2 illustrates a comfort relation network in an exemplary embodiment;

FIG. 3 illustrates community detection in an exemplary embodiment; and

FIG. 4 is a flowchart of comfort estimation and incentive generation in an exemplary embodiment.

### DETAILED DESCRIPTION

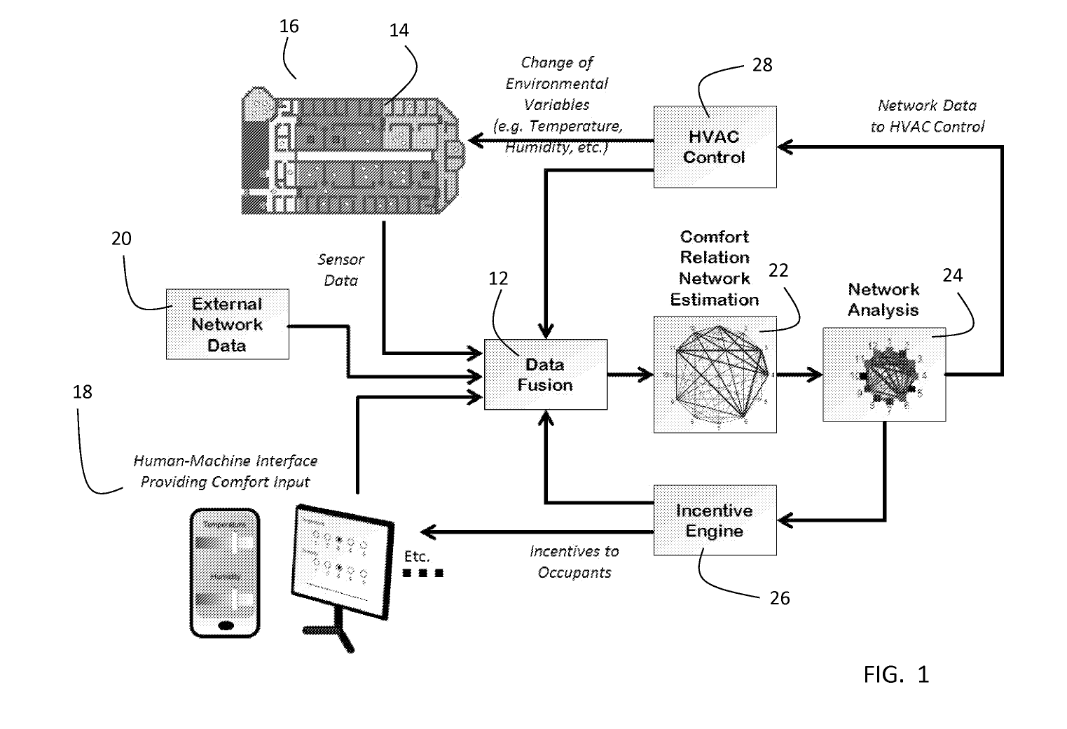

FIG. 1 illustrates a comfort estimation and incentive system in an exemplary embodiment. Portions of the system may be implemented by a general-purpose computer (e.g., a server) or a dedicated system (e.g. Building Automation System) executing a computer program stored on a storage medium and containing instructions for implementing the elements and processes described herein. The comfort estimation and incentive system may be part of a building management system, or operate in conjunction with an existing building management system.

A data fusion module 12 collects information from a variety of sources. Sensor data is provided to the data fusion module 12 from sensors 14 located in a space 16. Space 16 may correspond to a floor of a building, an entire building, a plurality of different buildings, or any space conditioned by the system, such as an HVAC (Heat Ventilation and Air Conditioning) zone. Sensors 14 may collect environmental data such as temperature, humidity, air quality (e.g. using CO2 sensors), etc. Sensors 14 may be permanent fixtures in the space 16 or may be sensors worn by occupants of the space 16, or a combination of the above.

Occupant comfort data is provided from a user interface 18 in the form of votes about their comfort level. User interface 18 may be implemented using a kiosk or a wall mounted touch screen. User interface 18 may also be provided through an application executing on a mobile device, at a point of sale, etc. Alternatively, the user interface 18 may be implemented via a remote device accessible over a network, such as a web site where a user can log in and remotely enter comfort data. The comfort data may include a comfort vote, such as an approval or disapproval, for the current temperature, humidity, noise, etc. Information about the clothing worn by an occupant may also be collected. Further, the comfort data may include information about the occupant, such as age, gender, role, etc.

External network data 20 may be provided from a variety of sources. For example, data fusion module 12 may collect data from web-based social networks to which occupants can subscribe in exchange for incentives. This data is used by the system to better estimate the comfort relation network and obtain information directly from occupants. Trust can be, for example, estimated to increase the weight of feedback information from certain sub-set of occupants. Feedback is provided to the occupants through dashboards and incentives are provided in any form, e.g. money, reduced utility costs, etc. The comfort relation network can be augmented by information provided by the users from social networking systems (e.g. occupants can be asked to link their FACEBOOK® profile with the building FACEBOOK® page, etc.). This type of information can be used to augment the comfort relation network with other information (e.g. age, preferences, gender, role, etc.) and used to estimate trust of occupants. In this context, trust is used by the system to determine how to weigh comfort inputs and filter out deceiving behaviors, etc.

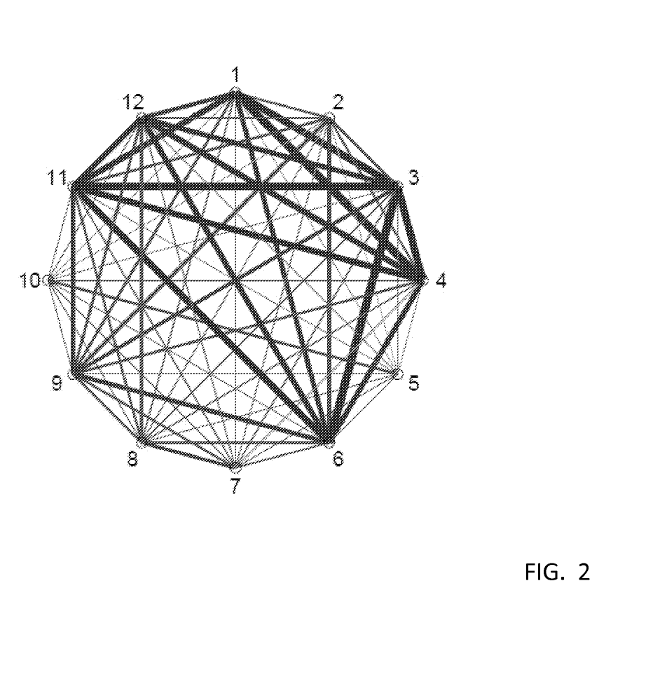

The data collected by data fusion module 12 is combined and then provided to comfort relation network estimation module 22. The comfort relation network estimation module 22 generates a comfort relation network as described in further detail herein with reference to FIG. 2. The comfort relation network represents the similarity/dissimilarity of comfort among the various occupants of space 16. The comfort relation network can also be augmented to consider other types of information, e.g., age, gender, role in the company/school/laboratory/etc., etc. The comfort relation network provides a representation of the comfort relation as well as relative information among the occupants of the building.

A network analysis module 24 analyzes the comfort relation network to determine communities of people sharing similar comfort metrics. The comfort metrics may be combined with other occupant information such as age, role, etc. The detection of communities by network analysis module 24 is described in further detail herein.

Incentive engine 26 receives the communities output by the network analysis module 24 to design an incentive strategy that influences people to be more energy efficient. This may be done through peer-pressure (e.g., showing other people's behavior or a ranking of people based on energy efficiency) or providing monetary incentives to individuals or a group of individuals that are more energy efficient. In the context of comfort, the incentive engine 26 refers to the design of energy efficient rules and price policies, so that occupants strive to maximize their benefit (e.g., monetary incentives) while reducing comfort (e.g., reducing room temperature). Occupants can exchange messages, directly (e.g., by mean of human communication) or indirectly (e.g. peer-pressure from public dashboards etc.).

The communities output by the network analysis module 24 are also used to regulate the environment control system 28 (e.g., HVAC system) to provide the right comfort level as required by the occupant(s). When HVAC system is highly underactuated (e.g., only a few actuators compared to the number of occupants in a zone), network data can be used to consider a weighted average of occupant's comfort. For example, if in a zone only two occupants out of ten desire a certain temperature, which however turns out to improve the overall building/zone efficiency, the controller can weigh their information more. Of course, in this case incentives for the remaining occupants might be needed to maintain good comfort levels.

FIG. 2 illustrates a comfort relation network for twelve occupants of space 16. Each occupant is represented by a number, ranging from 1 to 12 in FIG. 2. In the example of FIG. 2, the comfort relation network is generated based on (i) overall comfort vote from each occupant, (ii) measured temperature and (iii) measured humidity. Other factors could be used and embodiments of the invention are not limited to the factors recited in this example.

In order to create the comfort relation network, where the relation metric is defined by a combination of sensor data as well as comfort votes, a distance is computed for each pair of occupants. An exemplary distance measure is the earth mover distance (EMD). EMD is a measure of distance between two probability distributions on a domain. If the probability distributions are interpreted as two ways of piling earth in a certain region, the EMD corresponds to the minimum cost of turning one pile into the other, where cost is expressed as the product of the amount of earth moved times the distance by which is moved. In order to associate a probability density to each occupant, the conditional probability p(v|t, h) is determined from the data. The conditional probability expresses the probability of a comfort vote given the measured temperature and humidity.

In order to compute the EMD, the following optimization problem is used. Let us define

$$q = ( \begin{matrix}{t}_{1} & {t}_{2} & … \\ {h}_{1} & {h}_{2} & …\end{matrix} )$$

as the set of normalized temperature (tₗ) and normalized humidity (hₗ) corresponding to the probability mass function associated to person i and, similarly, rⱼ is associated to person j. Denote with qᵢ and rⱼ the i-th and j-th data record in q and r, respectively. Let dᵢⱼ=∥qᵢ−rⱼₖ∥, the EMD problem is

$${min}_{fij} {\sum }_{i = 1}^{m} {\sum }_{j = 1}^{n} {f}_{ij} {d}_{ij}$$

$$s . t . {\sum }_{i = 1}^{m} {f}_{ij} \leq 1 ∀ j$$

$${\sum }_{j = 1}^{n} {f}_{i , j} \leq 1 ∀ i$$

$${\sum }_{i = 1}^{m} {\sum }_{j = 1}^{n} {f}_{ij} \leq 1$$

$${f}_{i , j} \geq 0 ∀ i , j$$

from which EMD is defined as

$$EMD = ( i , j ) = \frac{{\sum }_{i = 1}^{m} {\sum }_{j = 1}^{n} {f}_{ij}^{*} {d}_{ij}}{{\sum }_{i = 1}^{m} {\sum }_{j = 1}^{n} {f}_{ij}^{*}}$$

where f*ᵢⱼ is the optimal flow to move one probability mass function to the other.

The comfort relation network is then built considering the EMD between any pair of occupants for which data was recorded. An exemplary comfort relation network is shown in FIG. 2. The EMD between each pair of nodes is indicated with a thickness representing how strongly (small value of EMD) or weakly (large value of EMD) two nodes are related. In the comfort relation network, the value of EMD represents how much or how little two people share the same notion of comfort. FIG. 2 represents strong connections with thicker lines and weak connections with thinner lines. A thicker line means that the EMD is small, or equivalently that the people share a similar comfort metric. A thinner line means that the EMD is large, or that people do not share the same concept of comfort.

Once the comfort relation network is derived by comfort relation network estimation module 22, network analysis module 24 detects communities in the comfort relation network estimation. A variety of community detection processes may be employed by network analysis module 24. An exemplary community detection process divides the comfort relation network based on modularity. Another exemplary community detection process provides a hierarchical clustering of the comfort relation network based on strength of connection.

The modularity based community detection process may consider any number of communities. When the number of communities is fixed to two, the modularity based community detection process extracts a strongly connected component of occupants {1, 3, 4, 6, 11, 12} from the comfort relation network of FIG. 2. Increasing the number of communities to three results in community {2, 5, 7, 8, 9, 10} being divided into two communities {5, 10} and {2, 7, 8, 9}. Adjusting the number of communities to four results in community {1, 3, 4, 6, 11, 12} further refined into two sub-communities {1, 3, 4} and {6, 11, 12}. The modularity value for the four community case is small and negative indicating that the obtained communities are forced rather than really existing in the network. Thus, it can be determined the total number of communities in the comfort relation network is three.

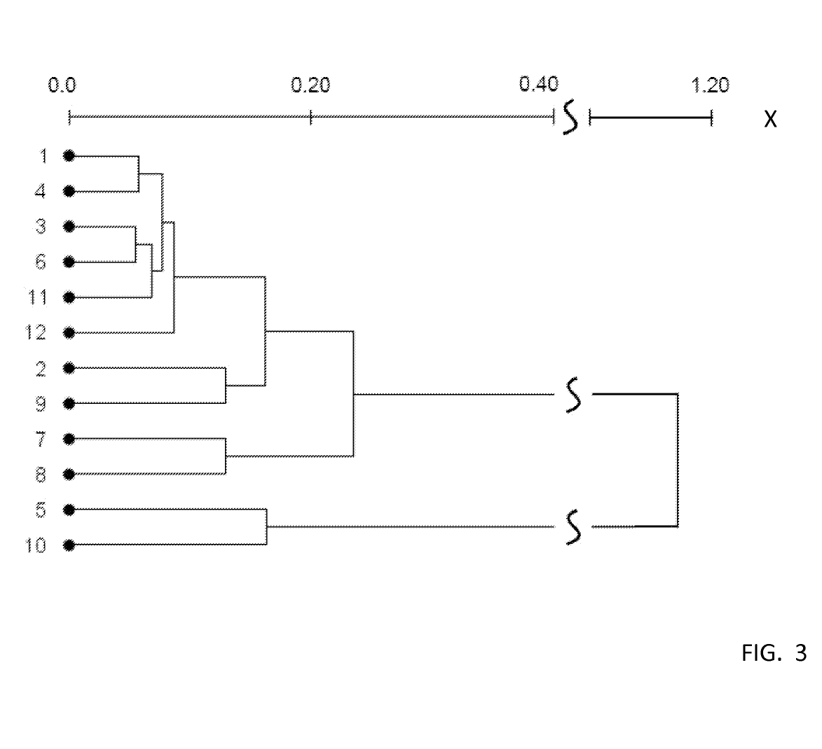

A second community detection process applies hierarchical clustering to the comfort relation network in FIG. 2. The hierarchical clustering may be based on an unweighted average. FIG. 3 depicts community detection based on hierarchical clustering. The x-axis in FIG. 3 is the distance between clusters of occupants as defined above. Nodes 1-12 represent occupants. As it can be seen clearly there are two main clusters in the network, one corresponding to the nodes {5, 10} and another to the remaining nodes. Within the larger graph there are a number of sub-clusters. In particular, nodes {1, 4} and {3, 6} form small sub-clusters that have similar distance values. Node 11 is the part of the sub-cluster {3, 6} for a slightly larger value of the distance and, similarly, node 12 is part of the sub-cluster {1, 4}. All these nodes together form a clear cluster with a relatively low value of the distance (about 0.15). As with the modularity based community detection, using the unweighted average metric clusters, the strongly connected nodes {1, 3, 4, 6, 11, 12} form a single cluster. For higher values of the distance, clusters {2, 9} and {7, 8} are joined into the previous cluster for a distance value of 0.25. Note, however, that cluster {2, 9} is joined to the larger cluster {1, 3, 4, 6, 11, 12} for a lower value of distance, thus showing that the average distance between the cluster {2, 9} and the cluster {1, 3, 4, 6, 11, 12} is lower than that of the cluster {7, 8} and {1, 3, 4, 6, 11, 12}.

Communities can also be determined using spectral clustering directly on the Laplacian matrix associated with a weighted graph. Spectral clustering provides similar communities as the modularity based community detection. For large instances of the comfort graphs one can use fast decentralized clustering algorithms. It is understood that other community detection processes may be applied to the comfort relation network, and embodiments are not limited to the community detection processes described herein.

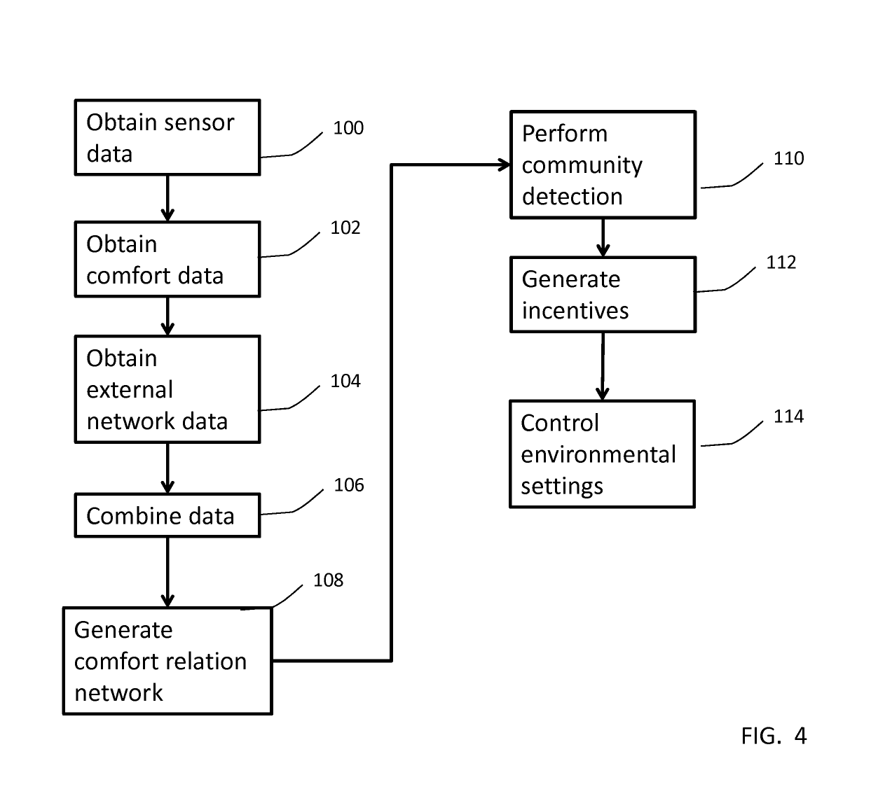

FIG. 4 is a flowchart of comfort estimation and incentive generation in an exemplary embodiment. The process begins at 100 where sensor data from sensors 14 is obtained by the data fusion module 12. At 102, comfort data is received by the data fusion module 12 from occupants through user interface 18. At 104, external network data 20 is received by the data fusion module 12. As described above, the external network data may include occupant information from social media websites, etc.

At 106, the data fusion module 12 combines the received data and provides the combined data to the comfort relation network estimation module 22. The comfort relation network estimation module 22 generates the comfort relation network at 108 as described above. At 110, the network analysis module 24 detects communities in the comfort relation network. At 112, the incentive engine 26 generates incentives based on the communities detected at 110. At 114, the communities detected at 110 are applied to environment control system 28 to adjust environmental settings (e.g., temperature) in space 16.

The methods described herein for the comfort control and incentive design for a single building can be extended and augmented for multiple buildings. In particular, buildings can not only utilize information directly provided by occupants, but can also augment this data with information coming from media, news, etc., as external network data 20. In particular, this becomes valuable for buildings where occupants are indoors periodically but sporadically, such as in shops, libraries, and in general public places. Occupants can provide information as external network data 20 concerning, e.g., their preferences of indoor climate for incentives (e.g., discounts, gift cards, etc.). Statistics about the time when people came to the building can provide better HVAC control (e.g., pre-cooling/pre-heating, ventilation, etc.). Events in a city, such as large concerts, etc., can be used by the building management system to scale down/up the presence of customers leveraging social network information. Media information can also be used to forecast occupants in some of public buildings. Better forecast of HVAC, lighting, etc., can be shared from the buildings back to the utility companies that can better forecast demand.

Embodiments relate to a system that provides incentives to the occupants of a building in order to be more energy efficient and a method to estimate the comfort inter-relation among occupants, which is used to design the incentives. Embodiments provide numerous advantages by combining social aspects (e.g., role, age, gender, etc.) with comfort voting provided by the occupants through a user interface and/or wearable sensors and sensors measuring environmental information (e.g. temperature, humidity, etc.). Embodiments estimate comfort relations among occupants to provide a comfort relation network that it is used to help a building manager to make decisions on re-allocation of people in the building based on their comfort similarities/dissimilarities as well as decide what occupants to incentivize to be more energy efficient. The comfort relation network can identify uncomfortable communities in the building and investigate causes (e.g., bad insulation, mistuned controls, etc. or insufficient heat/cool). Embodiments combine building improvement decisions with occupant comfort to increase energy efficiency with limited cost. For example, if there is a community of people comfortable at relatively low temperatures and there is a part of the building that is typically cool because of poor insulation, etc., there is no need for improving that part of the building quickly as those occupants could be moved in that part of the building. These decisions can also be coupled with government incentives to maximize energy efficiency and comfort with contained costs. Embodiments utilize estimates of comfort information and social network analysis to provide incentives to occupants to improve the energy efficiency of the building. Embodiments provide a framework that is scalable to a district level, thus involving a large number of private buildings (e.g., apartment complexes, offices, shops, etc.) as well as public buildings (e.g., hospitals, libraries, schools, malls, etc.).

As described above, the exemplary embodiments can be in the form of processor-implemented processes and devices for practicing those processes, such as a server or building automation system. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1. A method for providing comfort estimation for a space, the method comprising:
receiving sensor data identifying an environmental condition for the space;
receiving comfort data from occupants of the space;
combining the sensor data and comfort data to provide combined data;
generating a comfort relation network in response to the combined data; and
performing network analysis on the comfort relation network to identify communities within the comfort relation network.

2. The method of claim 1 further comprising:
generating incentives in response to the communities, the incentives designed for the occupants to reduce energy consumption.

3. The method of claim 2 further comprising:
providing the incentives to the occupants.

4. The method of claim 1 further comprising:
providing the communities to an environment control system, the environment control system controlling an environmental variable at the space.

5. The method of claim 1 wherein generating the comfort relation network includes determining a distance between comfort data for each pair of occupants providing comfort data.

6. The method of claim 1 wherein performing network analysis on the comfort relation network to identify communities within the comfort relation network includes performing a community detection process.

7. The method of claim 1 wherein performing network analysis on the comfort relation network to identify communities within the comfort relation network includes determining at least one of age, gender and role of the occupants.

8. The method of claim 1 further comprising:
receiving external network data from an external network, the combined data including the sensor data, the comfort data and the external network data.

9. The method of claim 1 wherein the space includes a plurality of distinct spaces in multiple buildings.

10. A system for providing comfort estimation for a space, the system comprising:
a data fusion module receiving sensor data identifying an environmental condition for the space, receiving comfort data from occupants of the space and combining the sensor data and comfort data to provide combined data;
a comfort relation network estimation module generating a comfort relation network in response to the combined data; and
a network analysis module performing network analysis on the comfort relation network to identify communities within the comfort relation network.

11. The system of claim 10 further comprising:
an incentives engine for generating incentives in response to the communities, the incentives designed for the occupants to reduce energy consumption.

12. The system of claim 11 wherein:
the incentives engine provides the incentives to the occupants.

13. The system of claim 10 further comprising:
an environment control system, the environment control system controlling an environmental variable at the space in response to the communities.

14. The system of claim 10 wherein the comfort relation network estimation module determines a distance between comfort data for each pair of occupants providing comfort data.

15. The system of claim 10 wherein the network analysis module performs network analysis on the comfort relation network to identify communities within the comfort relation network by performing a community detection process.

16. The system of claim 10 wherein the network analysis module identifies communities within the comfort relation network by determining at least one of age, gender, preferences, and role of the occupants.

17. The system of claim 10 wherein the data fusion module receives external network data from an external network, the combined data including the sensor data, the comfort data and the external network data.

18. The system of claim 10 wherein the space includes a plurality of distinct spaces in multiple buildings.

19. A computer program embodied on a non-transitory computer-readable storage medium, the computer program including instructions for causing a processor to implement a process for providing comfort estimation for a space, the process comprising:
receiving sensor data identifying an environmental condition for the space;
receiving comfort data from occupants of the space;
combining the sensor data and comfort data to provide combined data;
generating a comfort relation network in response to the combined data;
performing network analysis on the comfort relation network to identify communities within the comfort relation network; and
providing incentives to the occupants to promote energy efficient behavior.
